(19) United States
(12) Patent Application Publication
(10) Pub. No.: US 2006/0092160 A1
(43) Pub. Date: May 4, 2006

(54) Method for the rapid image processing of medical images

(76) Inventors: Christopher Drexler, Lake in the Hills, IL (US); Joachim Hornegger, Mohrendorf (DE); Martin Mack, Koblenz (DE)

Correspondence Address: SIEMENS CORPORATION;INTELLECTUAL PROPERTY DEPARTMENT, 170 WOOD AVENUE, SOUTH, ISELIN, NJ, 08830, US

(21) Appl. No.: 11/254,967

(22) Filed: Oct. 20, 2005

(30) Foreign Application Priority Data
Oct. 22, 2004 (DE) 10 2004 051 568.9

(51) Int. Cl. G06F 15/16

(52) U.S. Cl. 345/504

(57) ABSTRACT

The present invention relates to a method for the rapid image processing of medical images, in particular fluoroscopic image recordings using image-modifying image processing algorithms on an image computer. With this method, a first part of the image processing algorithms is executed on a graphics processor of a graphics card and a second remaining part is executed on a master processor of the image computer. This division, for which standard hardware components are to be used, allows the omission of complex special developments of the hardware for the image computer.

### CROSS REFERENCE TO RELATED APPLICATIONS

This application claims priority to the German application No. 10 2004 051 568.9, filed Oct. 22, 2004 which is incorporated by reference herein in its entirety.

1. Field of the Invention

The present invention relates to a method for the rapid image processing of medical images, in particular fluoroscopic image recordings, using image-modifying image processing algorithms on an image processor.

2. Background of Invention

Medical-specific imaging methods such as computer tomography, x-ray angiography or magnetic resonance tomography for instance, require complex image processing of the images recorded using the corresponding modalities. This image processing is intended on the one hand to improve the image quality, for example by noise suppression, and on the other hand to highlight structures in the images essential for the respective diagnosis, for instance by means of edge sharpening or filtering.

### SUMMARY OF INVENTION

Rapid image processing is necessary particularly in the field of fluoroscopy, in which x-ray recordings of an examination area are recorded in rapid temporal sequence and displayed immediately on a screen for the attending doctor. With modern fluoroscopy systems, the images are already processed at a speed of 30 frame/s with a resolution of 1024×1024 pixels and a bit depth of 16 bits. Image processing with the image-modifying and/or image-improving image processing algorithms takes place on an image computer connected to the recording modality. The image processing algorithms are combined in the so-called post-processing pipeline. The main problem of image processing is the high processing speed, as the doctor requires the images in real-time where possible for instrument navigation in the case of interventions, particularly with the use of a catheter.

With current master processors, the processing speed needed for this purpose cannot be achieved with the above image resolutions.

For this reason the post processing pipeline has hitherto been specially designed for this application of developed hardware. The image computer thus represents a special development using DSP boards (digital signal processing), onto which the image processing algorithms are executed. To this purpose, the algorithms must be written in a hand-optimized Assembler Code. The development of the special hardware and the implementation of the image processing algorithms are very time and cost-intensive. Furthermore, a special development of this type fails to allow flexible exchange of the hardware due to necessary board developments or the use of faster processors, since this potentially requires a complex reimplementation of the image processing algorithms.

An object of the present invention is thus to specify a method for the rapid image processing of medical images, requiring lower investment costs and exhibiting greater flexibility in terms of new hardware development.

The object is achieved by the claims. Advantageous embodiments of the method are the subject matter of the dependent claims or can be inferred from the subsequent description as well as the exemplary embodiment.

With the present method for the rapid image processing of medical images, in particular fluoroscopic image recordings using image-modifying image processing algorithms on an image computer, a part of the image processing algorithms, arbitrarily referred to below as the first part, is executed on a graphics processor of a graphics card and a second remaining part is executed on a master processor of the image computer.

With the present method, the DSP boards used to date are thus replaced by graphics cards, and the execution of the image processing algorithm is divided onto at least two components of the image computer. One part of the image processing algorithm is executed on the master processor and another part on the graphics card processor. This takes advantage of the fact that standard graphics cards are available with graphics processors, onto which a part of the image processing algorithm can be executed with sufficiently high speed. For the applications mentioned at the start, in particular in fluoroscopy, the division of the computing power onto master and grahics processors achieves a satisfactory processing speed.

One particular advantage of the present method is that no special hardware developments are necessary any more for the image computer. The use of standard interfaces with the graphics cards for the implementation of the image processing algorithms allows a trouble-free exchange of the graphics cards, for instance the use of faster graphics processors, without having to carry out a laborious reimplementation of the algorithms. This advantageous also applies to the use of faster master processors, which can be used without program modifications (Drop-In-Replacement). The investment costs are considerably reduced for the image computers by the use of standard hardware made possible using the present method, which is produced for a wider market and is correspondingly more cost-effective than special hardware.

One or a number of pixel shader units of the graphics cards is preferably used for the two-dimensional image processing. Thus a graphics card is available for instance with the Radeon 9700 Pro Graphics Card of ATI and subsequent models of this series, said graphics card having programmable pixel shader units of this type with a computing accuracy of 16 bit per color channel, as required for the post processing algorithms in the fluoroscopy applications with images of a bit depth of 16 bits mentioned in the description introduction. The standardized DirectX-9.0 API can be used as programming interfaces for the graphics card for instance.

In a preferred development of the present method, the second part of the image processing algorithm, which is executed on the master processor, is implemented via a command extension available with standard processors for the rapid parallel signal processing, such as in MMX, SSE, SSE2. The combined use of this command extension of the master processor and the use of pixel shade units on the graphics processor allow a very rapid calculation of the post processing algorithms on this standard component. The implementation of the post processing pipeline using standard hardware and the use of standardized programming interfaces and command sets can be solved in a more rapid, significantly more cost-effective and flexible manner than special hardware used to date. With the present method, algorithms which can not yet be implemented on graphics processing, are stored on the master processors, so that the method offers the best possible flexibility, also in terms of modifications to standard hardware.

### BRIEF DESCRIPTION OF THE DRAWINGS

The present method is described in more detail below with reference to an exemplary embodiment in conjunction with the drawing, in which;

FIG. 1 shows the data flow for image processing of medical image data according to the prior art, and;

FIG. 2 shows the data flow for image processing of medical image data according to the present method.

### DETAILED DESCRIPTION OF INVENTION

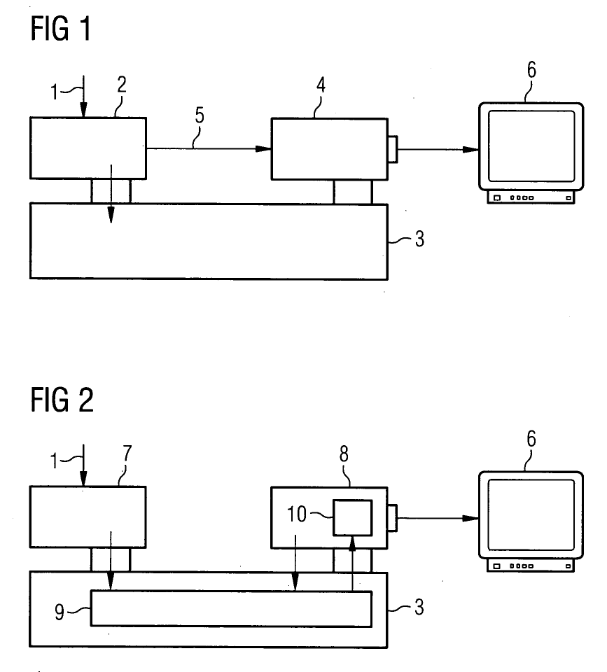

FIG. 1 shows an example for the ratio with the image processing of medical images which are hitherto present with the x-ray imaging. The raw data obtained by the x-ray detector 1 is directly fed to a digital signal processor 2 (DSP) which carries out the complete image processing. The digital signal processor 2 is additionally provided at a conventional PC3, by means of which the command input is effected. The image data processed by the digital signal processor 2 (DSP) is fed to a special graphics card 4 by means of a direct link 5, by means of which the processed images are displayed on a monitor 6. The master processor of the PC 3 does not take part in the image processing, but can however receive the processed image data from the digital signal processor 2, in order to store these for instance for a later display or further processing.

Contrastingly, FIG. 2 shows the conditions present in the implementation of the present method. In this example, the raw data is acquired by an x-ray detector 1 by means of an acquisition card. This acquisition card serves solely to record the image data without image processing. The raw image data is then divided onto two components of the image computer. One part of the image processing takes place on the master processor of the PC 3. This part of the image processing is indicated in the Figure using a reference character 9. Another part of the image processing takes place on the graphics processor of the high end standard graphics card 8 used, which has one or a number of suitable pixel shader units for the image processing. This other image processing element is indicated in the Figure with the reference character 10. The graphics card 8 thus in turn outputs the processed images at the monitor. Furthermore, the processed images can be transmitted from the graphics card 8 to the PC 3 and stored there for a subsequent representation or further processing.

This division of the image processing algorithms onto the processor/processors of PC 3 or the processor/processors of graphics card 8 allows a sufficiently fast image processing with cost-effective, available standard components. A development of special hardware with the aforementioned related problem is no longer necessary.

1-5. (canceled)

6. A method of processing medical images, comprising:
providing an image computer comprising a master processor and a graphics card, the graphics card comprising a graphics processor;
providing image-modifying image processing algorithms comprising first and second parts;
implementing the image-modifying image processing algorithms on the image computer, the image-modifying image processing algorithms distributed among the master processor and the graphics processor, the first part implemented on graphics processor, the second part implemented on the master processor;
executing the first part on the graphics processor; and
executing the second part on the master processor.

7. The method according to claim 6, wherein the medical images are fluoroscopic image recordings.

8. The method according to claim 6, wherein the graphics processor comprises a plurality of pixel shader units, the first part executed by at least one of the pixel shader units.

9. The method according to claim 6, wherein the graphics card is an off-the-shelf graphics card.

10. The method according to claim 6, wherein the first part is programmed using a standardized interface for executing the first part.

11. The method according to claim 6, wherein the second part is implemented on the master processor using command extension available with standard processors, the command extension related to rapid parallel signal processing.
